(19) United States
(12) Patent Application Publication
(10) Pub. No.: US 2005/0119115 A1
(43) Pub. Date: Jun. 2, 2005

(54) Catalyst for thermal cracking of vegetable and mineral oils, plastics, rubbers and dehydration of castor oil

(76) Inventors: Camlio Machado, Goiania (BR); Afranio Dau Machado, Goiania (BR)

Correspondence Address: Camilo Machado Jr, Q1 25 Lote 12 Bloco E Apt 626, Quara II Brasilia DF 71060 054, BR

(21) Appl. No.: 10/221,755

(22) PCT Filed: Mar. 12, 2001
(86) PCT No.: PCT/BR01/00024

(30) Foreign Application Priority Data
Mar. 14, 2000 (BR) PI 0001302-1

(51) Int. Cl. B01J 27/24; B01J 31/00

(52) U.S. Cl. 502/200; 502/150

(57) ABSTRACT

A Catalyst is produced, based on humic substances, that allows the accomplishment of thermal-catalytic cracking reactions of vegetable and mineral oils and of polymers such as plastics and natural or synthetic rubbers, where the reactions occur at temperatures below 400° C., as well as the process of dehydration of the castor oil. The preparation of the compound called “Catalyst” is based on a chemical reaction of humic substances in the presence of a base, preferably NH₄OH.

### BACKGROUND OF THE INVENTION

### FIELD OF THE INVENTION

The present invention refers to a catalyst based on humic substances and to the corresponding process for its production. This catalyst consists of a chemical compound with excellent properties to perform the thermal cracking of oils, fats, greases, new or used vegetable and mineral waxes, and resins, which will be called vegetable and mineral oils. In addition, it has excellent properties to perform the thermal cracking of the petroleum derivatives, the petroleum itself, resins and used automobile oils, which will be called mineral oils. It also provides the thermal cracking of plastics and natural or synthetic rubbers and makes possible the dehydration of the castor oil.

Due to its physical and chemical properties, this catalyst mixes perfectly with substances to be dehydrated and cracked, performing the dehydrating and cracking reactions in lower temperatures than in relation to usual processes. Furthermore, it increases the speed of the process and the efficiency of the final products.

Renewable and alternative Hydrocarbons (fuels) as well as a number of chemical derivatives can be obtained from the process of thermal-catalytic cracking of oils, fats, greases and vegetable and mineral waxes.

Vegetable oils and their derivatives have been used in a number of applications as substitutes for diesel oil. The European Community invested successfully in the research of renewable vegetable fuels, by using canola oil as the raw material most used in Europe.

One of the most common use of vegetable oils for fuel production has been the so-called Biodiesel, which is obtained through a chemical process that transesterfies new or used vegetable oils.

On the other hand, another possible way to obtain renewable liquid fuels from vegetable oils, although not as widely used as the transesterification or alcoholysis process, is the thermal-catalytic cracking of new or used vegetable oils. This method consists of heating up vegetable oils, previously mixed with a catalyst, to temperatures ranging from 400 to 450° C., in order to obtain hydrocarbons (fuels).

The resulting mixture may be distilled and separated in fractions similar to those obtained in the fractionating process of the natural petroleum.

According to the technical literature, some catalysts are widely known, such as: Al₂O₃, CaO, MgO, ZnCl₂, MgCl₂ and BaCl₂.

[Ref.: Revue de L'institut Frangais du Pétrole, Vol. 38, n. 1, January-February 1983].

The greatest obstacle concerning the thermal-catalytic cracking process of vegetable oil, has been the required high temperature, which reduces the overall global thermal efficiency, and may cause the oxidation of the chemical compounds that are obtained.

Some other challenges that have affected the use of the thermal-catalytic cracking process of vegetable oils are the low speed of reaction and the difficulty in eliminating the intermolecular water found in these oils.

These obstacles led to the few applications of this process in vegetable oils.

The cracking of the Petroleum derivatives and the residual products resulting from its distillation, such as fuel oil, heavy oil, etc, is a well-known process widely used by the refinery industry. One of the most common processes is the pyrolysis (decomposition of large hydrocarbon molecules into smaller ones by the action of heat), which is basically no longer in use nowadays; the other is the catalytic cracking, currently in use, through the cracking units of a fluidized bed and of a fixed bed, being part of complex facilities.

In the case of cracking of mineral oils, such as the petroleum derivatives or even the used mineral oils, there are some obstacles to the currently used catalysts. The first is the physical state of the residuals that are formed during the cracking reaction, which makes it difficult to be removed from the equipment. Second is the non-homogeneity of the mixture of some catalysts with oil, which requires the use of auxiliary equipment to keep them in suspension. Finally is the high involved temperature and the need of a vacuum to enhance the process.

The commonly used catalysts in the thermal cracking of petroleum are the silica-aluminum, the zeolytes and the amorphous argyles.

These catalysts and the catalytic cracking process used in the petroleum industry are mentioned in the book: “Indústrias de Processos Químicos”, R. Norris Shreve e Joseph A. Brink Jr., chapter 37—Refining of Petroleum—, 4^{th} Edition, 1977, pages 583 to 614.

### DETAILED DESCRIPTION OF THE INVENTION

Our research in this field started in the forties. An article about it was published on Jan. 21, 1942 in the newspaper “A folha da Noite de São Paulo”, concerning the production of synthetic fuels derived from castor oil.

From that experience, new research was carried out until a new catalyst was obtained.

The present invention has as objective the production of a catalyst for thermal cracking of vegetable and mineral oils, plastics, rubbers and dehydration of castor oil, making possible the reactions of dehydration and cracking in lower temperatures than in relation to the existing catalysts, i.e., below 400° C., in order to increase the thermal efficiency of the industrial process and of the final products. The aim is the production of several chemical derivatives that may be obtained in the cracking process, as well as the production of high-quality dehydrated castor oil.

The use of the new catalyst has provided several advantages in relation to the existing technology. In addition to what it performs with vegetable and mineral oils, it provides the cracking of oils, fats, animal greases and waxes, transforming all of them, by the same process, into hydrocarbons.

The thermal-catalytic cracking reaction of vegetal and animal oils demands low temperatures, in the range from 250 to 350° C., with no need of a vacuum, with excellent efficiency. The process of dehydration occurs with the application of a low intensity vacuum.

Because the dehydration and cracking processes occur in low temperatures, the obtained products are less oxidized and, therefore, purer.

It allows the elimination of intermolecular water from vegetable oils, offering a continuous cracking process with high-speed reaction.

It eliminates the need of auxiliary processing units or equipment such as catalyst injector and/or systems to keep catalyst in suspension.

It provides the cracking of polymers such as plastics and natural or synthetic rubbers.

It provides the dehydration of the castor oil in lower temperatures, thus significantly reducing its oxidation, making it more transparent and consequently more attractive to the industries.

The production of the catalyst is based on humic substances. Humic substances are part of the organic matter that after several transformations, remain in the environment and consist of a heterogeneous polifunctional mixture.

Such substances are found, for example, in the turf reserves.

In order to obtain 100 kg of the catalyst it is necessary to use 90 kg of previously ground turf in order to facilitate its dissolution. Add from 15 to 20 liters of water, preferably 18 liters, removing the mass that is transformed into thick liquid. Add, to this thick liquid, from 7 to 10 liters, preferably 8 liters, of ammonium hydroxide, NH₄OH, and remove the mass again. Shake the mixture, leaving the mass to dry out in the sun until obtaining a crystallized solid mass.

The obtained catalyst should be mixed with the vegetable or mineral oils for the cracking operation, in an amount within 18 to 25%, preferably 20%, of the mass of the oil to be cracked.

1a) “PROCESS FOR OBTAINING A CATALYST FOR THERMAL-CATALYTIC CRACKING REACTIONS OF OILS, FATS, VEGETABLE AND ANIMAL GREASES AND WAXES, RESINS, MINERAL OILS SUCH AS PETROLEUM AND ITS DERIVATIVES, AUTOMOBILE USED OILS AND POLYMERS SUCH AS PLASTICS AND NATURAL OR SYNTHETIC RUBBERS, AND FOR THE DEHYDRATION OF THE CASTOR OIL”, wherein the catalyst is obtained by the reaction of humic substances, obtained from the turf, and NH₄OH, being the added base in the range from 8 to 11%, in relation to the mass of the humic substances.

2a) “CATALYST BASED ON THE COMPOUND OBTAINED THOROUGH THE REACTION ACCORDING TO Claim 1”, wherein the catalyst provides the thermal cracking of oils, fats, vegetal and mineral greases and waxes, and resins for the production of hydrocarbons (fuels) and others chemical derivatives and the production of dehydrated castor oil.

3a) “CATALYST BASED ON THE COMPOUND OBTAINED THOROUGH THE REACTION ACCORDING TO CLAIM 1”, wherein the catalyst provides the cracking of vegetable oils for the production of hydrocarbons (fuels) and other chemical derivatives and allows the dehydration of the castor oil.

4a) “CATALYST BASED ON THE COMPOUND OBTAINED THOROUGH THE REACTION ACCORDING TO Claim 1”, wherein the catalyst allows the thermal cracking of mineral oils such as petroleum and its derivatives and resins, for the production of lighter hydrocarbons (fuels) and others chemical derivatives.

5a) “CATALYST BASED ON THE COMPOUND OBTAINED THOROUGH THE REACTION ACCORDING TO Claim 1”, wherein the catalyst allows the thermal cracking of used automobile oils (lubricant oils), for the production of lighter hydrocarbons (fuels) and others chemical derivatives.

6a) “CATALYST BASED ON THE COMPOUND OBTAINED THROUGH THE REACTION ACCORDING TO Claim 1”, wherein the catalyst allows the thermal cracking of polymers such as plastics and natural or synthetic rubbers for the production of lighter hydrocarbons (fuels) and others chemical derivatives.

7a) “CATALYST BASED ON THE COMPOUND OBTAINED THOROUGH THE REACTION ACCORDING TO Claim 1”, wherein the catalyst allows dehydration without cracking of the castor oil for several industrial applications.
